(19) United States
(12) Patent Application Publication
(10) Pub. No.: US 2002/0004187 A1
(43) Pub. Date: Jan. 10, 2002

(54) Energy efficient production of porous granules

(76) Inventors: James Ernest Ryan, Bunyip (AU); Godfrey John Pascoe, Bunyip (AU)

Correspondence Address: C. Frederick Koenig III, Esquire, Volpe and Koenig, P.C., One Penn Center, Suite 400, 1617 John F. Kennedy Boulevard, Philadelphia, PA, 19103, US

(21) Appl. No.: 09/867,965

(22) Filed: May 30, 2001

Related U.S. Application Data
(63) Continuation-in-part of application No. PCT/AU99/01064, filed on Nov. 30, 1999.

(30) Foreign Application Priority Data
Nov. 30, 1998 (AU) PP 7399

(51) Int. Cl. F27B 14/00

(52) U.S. Cl. 432/13; 432/58

(57) ABSTRACT

A method of producing porous calcined granules of a non-combustible material, the method including calcining agglomerates of said non-combustible material and a combustible material to effect combustion of said combustible material, wherein energy generated by the combustion of the combustible material is at least partially utilised for said calcining.

### FIELD OF THE INVENTION

This invention relates to a process for the production of porous granules. In particular, this invention relates to energy efficient production of porous granules.

While the invention is described with reference to the production of porous clay granules, it will be appreciated that this invention has application in processes for the production of porous granules formed of any suitable material.

The present invention generally relates to porous granules, processes for their production and their use as growing, water or oil absorbent mediums or filters. More specifically, the invention relates to porous granules that absorb high levels of water that can be released. Consequently the porous granules can be used as a soil replacement enabling both air and water to be supplied to plants.

Background of the Invention

Humus and loams are now in short supply and much of the superior soil in the world is being continually degraded. Clay could be converted into a growing medium if pores could be permanently incorporated therein to provide both water and air to plants economically. To be economically viable energy and process coasts must be low.

In the State of Victoria, Australia around one million tonnes of waste clays are produced from sand washing operations per annum and even more are produced worldwide. Few if any uses have been found for these clays, which sometimes contain sodium. The disposal of these clays involves de-watering operations either using flocculating plants or large ponds for solar drying and these processes incur costs. Tens of thousands of tonnes of wood waste are also produced from the timber industry in Victoria each year much of which is burnt. Some of these sources of wood waste are close to sources of waste clays.

It is advantageous for a growing medium to have a high level of available water to reduce the frequency of watering and the accompanying wastage of water and nutrients due to leaching. In summer, growers may have to irrigate their plants several timed a day and indoor plants often wilt because of the speed at which pots become dry. Composted pine-bark or sawdust particles are currently used to retain water, but little of the water stored within the particles themselves is available to the plant. Water holding can be greatly increased by reducing particle size, but this is at the expense of air porosity, which is essential for plant growth. Typically an aged pine-bark potting mix can contain about 16 vol % of available water and 20 vol % air. However, the pine-bark, which is an organic material, continues to decompose and the air porosity reduces with time.

A need accordingly exists to provide growing media in both horticulture and agriculture, which are able to provide both high levels of water and air and can be used to rehabilitate large tracts of land having poor soil.

There is considerable prior art, which describe the mixing of clay, and sawdust (or other particulate combustible material) and then firing the mixture in such a way that the sawdust is combusted to produce a porous calcined clay.

Porous calcined clay pellets have several applications particularly in horticulture where they may be used as a hydroponic growing medium, a propagation media, or a potting mix additive. For example U.S. Pat. No. 4,293,523 discloses an apparatus and process for producing potassium silicate comprising a step for kneading a mixture consisting essentially of potassium carbonate, fly ash, pulverized coal, other necessary starting materials and a caustic potash solution as a binder and then granulating the kneaded mixture, a step for drying the granulated product to a nearly absolutely dry state, and a step for calcining the dried granular product, whereby a chemical reaction takes place between the potassium and the silicon present in fly ash to convert them into a citric acid soluble potassium silicate. A process according to a second embodiment comprises a step for kneading a mixture consisting essentially of a potassium source, such as potash and/or potassium carbonate, fly ash, other components necessary for the production of citric acid soluble potassium silicate fertilizer and a binder, such as alcoholic waste liquor or the like, and then granulating the kneaded mixture, a step for drying the kneaded mixture to a nearly absolutely dry state, and a step for calcining the dried granular product, whereby a chemical reaction takes place between the potassium and the silicic acid present in fly ash to form a citric acid soluble potassium silicate. An apparatus for practicing the processes mentioned above comprises a plurality of continuous quantitative feeders, a continuous kneader, an extruder for forming granules, a fluid dryer, a fluid calcining furnace, and a cooling device for cooling calcined product.

However such apparatus and processes require a hot air generator as a heat source for fluid calcining furnace, where a fuel oil must be supplied from fuel tank to be burned to give the necessary hot air. Also the process requires a fluidised bed type of furnace equipped with a porous plate in which the granules are fluidised by hot air supplied from hot air generator and calcined at a temperature of about 600 degree to about 1,100 degree C. for about 15 minutes while thoroughly contacted with the hot air. The component of fly ash reacts with potassium to form citric acid soluble potassium. The high temperature waste gas leaving fluid calcining furnace is subjected to heat exchange in the first heat exchanger, and then again returned to hot air generator. The product, which has been calcined in fluid calcining furnace, is sent to high speed cooling device by screw feeder. High speed cooling device is a fluidised bed type of apparatus equipped with a porous plate in which the high temperature product is fluidised by low temperature air supplied by cooling air fan. There is thorough contact between the product and the low temperature air so that cooling progresses quite rapidly. Hot air leaving high speed cooling device is sent to fluid dryer where it is used as a drying medium. Such a fluidised bed system is extremely expensive and therefore not a viable proposition in many cases.

The process is also complex requiring cooled product to be pulverized and then transported into product storage tank where it is stored. Floating dust forming in the product storage tank is recovered by means of transportation fan and returned to pulveriser. Product stored in product storage tank is sent to granulator by screw feeder. On the other hand, water or a water-soluble binder is also fed to granulator by continuous quantitative feeder. After being granulated, the product is sent to second fluid dryer.

Prior art methods of producing porous clay granules typically include initially mixing the clay with a combustible particulate material such as sawdust. The mixture of clay and sawdust may then be pelletised, before being dried, and calcined. It is during calcination of the pellets that the sawdust is combusted, resulting in porous clay granules.

German patent application No. 3823641 describes the manufacture of expanded, porous, ceramic granules from a mixture of lean bleaching earth and fatty bleaching earth. The energy produced in the process can be at least partially used to support the energy requirement of a parallel procedure in which rich bleaching clay is boiled.

Australian patent No. 583750 describes a method of treating combustible waste materials. The method includes combining the waste material with a binder, forming pellets of the combined material, and passing the pellets successively through pyrolysis, oxidation, and vitrification zones. The volatile gases produced in the pyrolysis zone are used as fuel gas for combustion in the oxidation and/or vitrification zones.

It is an object of the present invention to provide an improved process of producing porous, calcined granules.

### SUMMARY OF INVENTION

The present invention provides a method of producing porous, calcined granules, which makes efficient use of the available energy. The present invention is based on the recognition that the process of manufacturing porous, calcined granules generates significant amounts of energy.

The present invention accordingly provides a method of producing porous calcined granules of a non-combustible material, the method including calcining agglomerates of said non-combustible material and a combustible material to effect combustion of said combustible material, such that energy generated by the combustion of the combustible material is at least partially utilised for said calcining.

Advantageously, prior to forming agglomerates of the non-combustible and combustible material, the combustible material is dried. This drying step is particularly suitable when the combustible material is sawdust. The combustible material is preferably dried at 260° C. or less until the water content of the combustible material is less than 30%, advantageously less than 10%. By reducing the water content of the sawdust it becomes more easily comminuted. After drying, the combustible material may be comminuted using any suitable method, the comminuted combustible material then being combined with the non-combustible material to form agglomerates.

Preferably, the agglomerates of combustible material and non-combustible material; are formed as pellets or spheres in which the combustible material is incorporated interstitially in the non-combustible material.

Before calcining, the agglomerates, preferably in the form of pellets or spheres, may be at least partially dried.

Advantageously, the non-combustible material is clay, clay slurry, ceramic, or similar material with ceramic properties.

Preferably said combustible material is sawdust or the like.

In another aspect the invention provides a method of forming porous, calcined granules including forming a mixture of a particulate combustible material and a non-combustible material, forming agglomerates of said mixture, at least partially drying said agglomerates, and calcining the agglomerates in a furnace such that energy generated by combustion of the combustible material is at least partially utilised for said calcining.

Advantageously, calcining is initiated by igniting the at least partially dried agglomerates, the calcining being sustained y the energy released by combustion of the combustible material.

Advantageously, the drying process involves subjecting the agglomerates to a rapid flow of hot air, which partially includes exhaust heat from the calcining process.

In another aspect, the invention provides a method of calcining a non-combustible material in a furnace such that the energy utilised for said calcination is at least in part derived from combustion of fuel incorporated interstitially in the, material being calcined.

In this and other aspects, sufficient heat energy is provided by combustion of the combustible fuel contained within the pellets or spheres so as to partially fuse and calcine the non-combustible material. As a result, the calcining process is essentially self-sustaining in that no external energy input is required after initial ignition of the pellets or spheres.

### BRIEF DESCRIPTION OF DRAWINGS

The invention will now be described with reference to the accompanying drawings by way of example in which:

FIG. 1 is a materials flow chart of an embodiment of the invention; and

FIG. 2 is a diagrammatic view of a furnace used with the invention

FIG. 3 is a diagrammatic view of a comminutor in accordance with the invention;

FIG. 4 is a partial expanded view of a nip area of the comminutor of FIG. 3.

### DESCRIPTION OF PREFERRED EMBODIMENTS

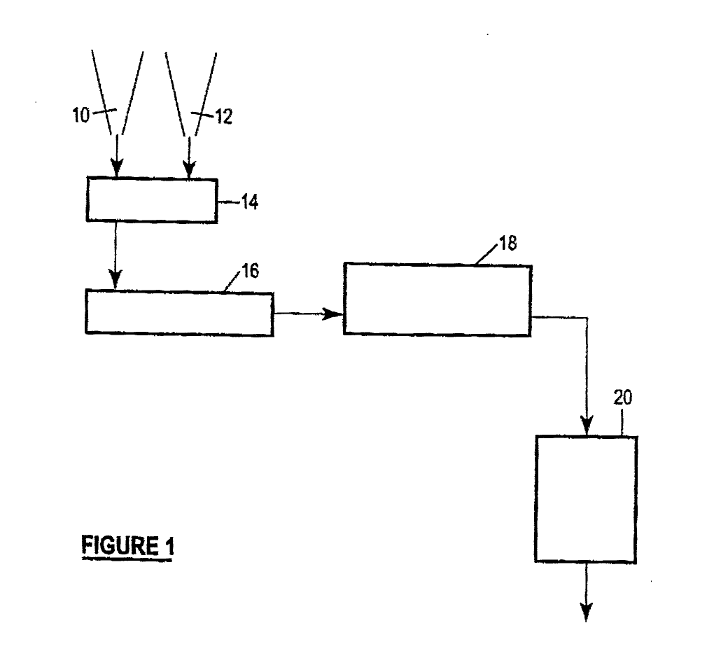

Referring to FIG. 1, combustible material is provided in the form of sawdust or similar material at 10. Prior to mixing with non-combustible material 12, the sawdust 10 is preferably dried and comminuted. Where the combustible material is not sawdust, for example waste paper pulp, then this initial drying step may be excluded. The mixture is then mixed in mixer 14 before being formed into agglomerates in extruder 16, preferably into pellets or spheres. The agglomerates are then dried in dryer 18 and passed to the furnace 20. Calcination of the non-combustible material occurs in the furnace 20 and porous, calcined granules exit from the furnace 20.

Primarily the raw materials used are clay and wood waste. However generally any siliceous material can be used with any cellulosic material and/or carbonaceous material. The use of different materials will require a suitable preparation in order to fulfill the steps of mixing, pelletisation and calcination.

The term “siliceous material” is used herein in its broadest sense and refers to any material containing silicon or silicon compounds such as wet clays (muds, slimes, sludges) dry clays, sand and mining tailings. Preferably the siliceous material is a siliceous waste such as a clay sludge, mud, or slime produced from sand washing operations or tailings from mining operations.

Preferably the material used is waste clay from a clay slurry. Such material can be processed by flocculation and further processing in a filter belt press, which dewaters the material to some 40 to 60%. The resulting material

Referring to the drying and comminution processes, which occur prior to mixing, combustible material in the form of sawdust is dried at 260° C. or less to achieve a water content of less than 30% and ideally less than 10% in a rotary dryer. Residence time in the dryer is about 2 minutes when sawdust is dried at a temperature of 260° C.

Comminution of the dried sawdust may be performed using existing, moiling methods and equipment. Comminution of the dried sawdust serves to reduce the sawdust to smaller fragments—the size of the fragments of sawdust determining the size of the pores in the porous, calcined granules finally produced. Prior to comminution, the size of the sawdust particles may be in the range up to 3 mm. After comminution, the particle size distributions typically 5%: 300 microns to 1 mm, 90%, 30 microns to 300 microns, and 5%/; less than 30 microns.

The clay and comminuted combustible material are then mixed into a dough and extruded to form pellets. The mixing process can also be used to break down the combustible material. If spherical shape is desired then this can be achieved by roiling the pellets in a rotating drum after they are extruded.

The pellets are then dried and calcined. In this invention these two stages are preferably integrally linked and make use of the heat generated by combustion of the sawdust during calcining.

In general, the pellets can be dried in any conventional manner, for example in a horizontal rotating cylinder through which hot air is blown. Alternatively, the wet granules are allowed to continuously pass under gravity through a vertical tank or drum through which hot air from the calcining furnace is blown, falling out through an exit hole in the bottom directly into the calcining furnace. They are dried by rapid flow of hot air, which is achieved through combination of exhaust heat from the furnace and input of cold air (the temperature being sufficient to rapidly dry the spheres but not to cause ignition of the comminuted sawdust). The drying process is very rapid and takes approximately 2 to 3 minutes depending on granule size, using a temperature of about 300° C.

Furnace 20 consists of a static, vertical, stainless steel cylinder 21, which is a closed system. The axis of the cylinder is aligned vertically. A rotary valve 22 is located at the top of the cylinder 21, offset from the axis of the cylinder, through which the pre-dried granules are fed directly from the dryer 18. Exhaust gases from the furnace are fed upwardly into the dryer 18 by ducts 28, 30 at the top of the furnace. A heating element (not shown) is located on the air inlet to the furnace 20 so that heated air is introduced into the furnace 20 to initially ignite the material. The method of heating the air can either be electrical, gas or solid fuel.

Uncalcined material is introduced into the furnace preferably at a rate not exceeding about 1 cm per minute to avoid smoke production and overheating and fusion of the granules due to too high a fuel loading. The flow rates of uncalcined granules into the furnace 20—and calcined granules out of the furnace are controlled in order to maintain a predetermined level of the granules in the furnace. This level can be anywhere between air sparge 34 and the top of the furnace. Preferably a space of at least 300 mm is left free above the burning granules as the combustion zone of the gases. This is essential to prevent smoke from being generated.

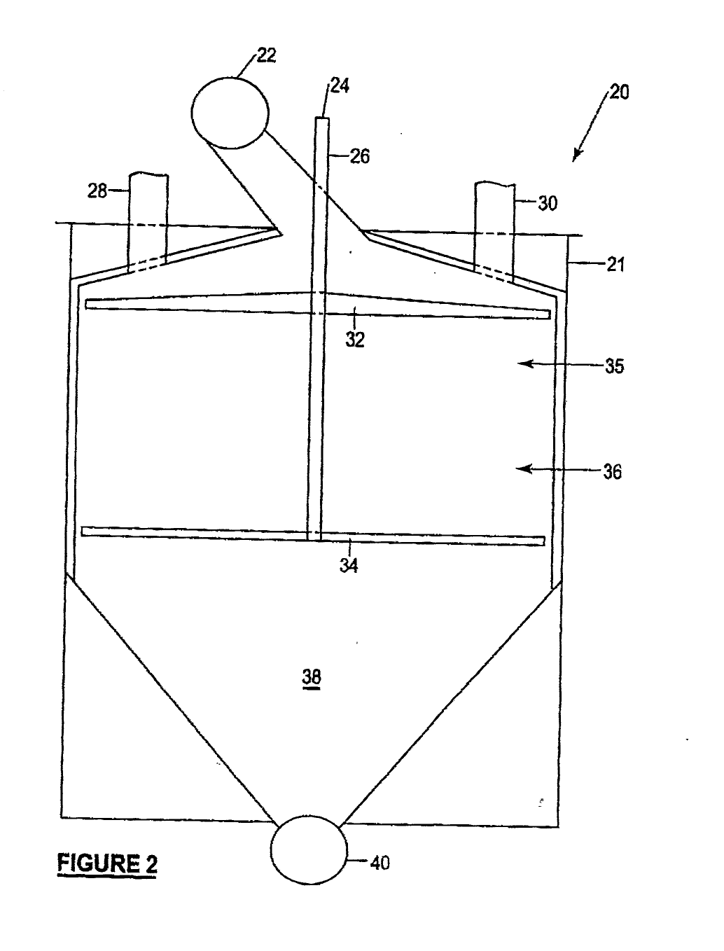

Referring to FIG. 2, as the granules enter the furnace 20, they are spread by a series of paddles 32 at the top of rathe cylinder 21, which are attached to a central rotating pipe 26. The central pipe 26 is attached to a variable speed drive (not shown). There are preferably four evenly spaced, radially extending paddles 32, which rotate with the central pipe 26. The paddles 32 ensure that the material is spread evenly across the cylinder 21 as it begins to diffuse downwardly through the furnace 20. As the material diffuses downwardly it passes successively through pre-heating 35, hot 36, and cooling 38 zones before exiting the furnace 20 at the lower end thereof.

In the preheating zone 35, hot gases from the hot zone 36 of the furnace flow upwardly through the material enabling the incoming materials to be fully snap dried and partially combusted as it is being evenly spread by the paddles 32.

The granules continue to diffuse downwards and calcining of the granules takes place spontaneously in the hot zone 36, which is formed at a controlled optimum height within the cylinder 21. As the granules fall on the hot material they quickly turn black due to carbonisation of the fuel and burn with a flame. As they pass down through the furnace 20 they start to glow red hot about 1 to 2 cm beneath the surface and continue to glow for a further 2 or 3 cm as the carbon near the surface of the granules is burnt. The temperature of this red-hot zone is preferably maintained at 700° C. to 900° C. by controlling airflow. At temperatures above 900° C. the granules tend to fuse together. At temperatures below 700° C. not all the carbon residues will have burnt away and the granules will be weaker in strength due to inadequate fusing of the clay colloidal particles.

As the red-hot granules pass further down the furnace 29 they turn black as they slowly run out of fuel. This black zone will extend for about a further 10 cm when most of the fuel has burned away. At this stage they will slowly cool although low levels of carbon residues will be slowly oxidised at the center of the granules. This cooling zone 38 is about a further 300 mm in depth. Cooling is achieved by airflow into the furnace 20 through air inlet 24, which is blown downwards into the cooling zone 38 by rotational air sparge 34. The rotating air sparge 34 is connected to the central rotating pipe 26 at the lower end thereof. The sparge consists of six radially extending pipes 34 which are preferably welded to and rotate with the central pipe 26 at the same speed as the paddles 32.

The granules diffuse downwards through the cooling zone 38 and when cooled exit through a rotational valve 40. The granules can then be bulk stored or loaded or can be bagged.

The speed of combustion will depend on granule size and smaller granules will burn out faster than larger ones since the fuel is more available. The combustion depth described is for granules of about 10 mm in diameter. Granules of 1 mm or less will burn much faster and the depth of the combustion zone is adjusted accordingly.

Cycle time may be regulated by adjustment of furnace temperature and/or the rate at which material is fed into the furnace. A short residence time can help ensure that nutrients and/or cation exchange capacity of the clay are not diminished by the calcining process. This would be important for horticultural applications of the product.

The interior temperature of the furnace can be controlled by varying one or more of the following:

(a) air regulation and distribution, which is achieved by varying the rotational speed of the sparge and the pressure of the air flowing, thought the sparge.

(b) Regulation of the speed of input of material through the rotary valve at the top of the unit.

(c) Regulation of the speed of output of material through the rotary valve at the bottom of the unit.

Exhaust gases from the unit arte directed via an intercooler and are then used for the pre-drying of the granules.

It will be appreciated that the furnace is a significant energy source. Surplus energy contained within the exhaust gases can be used for roasting of the sawdust, generation of electricity, or distillation of water from clay slurry.

It will also be appreciated that some waste clay slurries have a high salt content, as high as 6000 ppm which has been reduced to about 100 ppm using the process of the invention. Allowing a longer residence time in the furnace assists in reducing the salt content in the calcined product, which is desirable for horticultural applications of the product.

The cation exchange capacity and/or nutrient content of the calcined clay can be enhanced by adding particular clays such as montmorillinite and illite during the mixing process.

The low cost, porous calcined clay pellets, spheres or granules produced with this invention will have several applications.

Within horticulture the water absorption and water availability, air porosity, nutrient availability, and cation exchange capacity enable them to be used as:

1. hydroponic growing medium

2. a propagation media, used in the nursery industry to propagate plant cuttings

3. a wetting agent carrier, added to composted pine bark and other potting mixes to give the potting mix improved wettability

4. a potting mix additive, added to composted pine bark to give the potting mix improved buffering and cation exchange capacity as well as improved water holding capacity. The porous clay granules can be a substitute for perlite, vermiculite, peat, coir fibre etc presently used. In addition the replacement of larger pine bark particles (more than 5 mm) with porous clay granules would improve water absorption and water availability of the mix.

5. potting mix growing media in their own right, with differing optimum levels of air porosity and water availability being achieved for different plants by varying the particle size distribution of the sawdust

A growing medium with particle size range from 0.5 mm to 3 mm was manufactured using the process and was found to have a porosity of 22 volume percent and water absorption of 45 volume percent (most of which would have been readily available water). Very low cost production of the porous calcined clay granules can open the possibility of using them as an engineered soil to replace deteriorated and/or eroded agricultural soils.

Other possible applications for the low cost porous calcined clay granules, pellets or spheres include industrial oil absorbent, pet litter, or filtering material.

### EXAMPLE 1

Granules 10 mm in diameter were introduced into the continuous calciner of 1 m diameter at a rate of 7 liters per minute. The flow rate out of the furnace was controlled so that the level of granules was about 300 mm from the top of the furnace. The exit flow rate at this point was about 5 liters per minute due to the shrinkage of the material in the furnace.

The combustion was viewed through a clear side window and it noticed that the granules blackened after about 45 seconds. The red-hot zone extended a further 100 mm below this when the granules then started to extinguish upon cooling. The temperature of the red-hot zone was 850° C. as was the combustion zone above it.

The airflow was controlled using a leak off system and this was set at about 7 m³/min to avoid over heating and smoke production.

These flow rates were established in order to achieve a furnace temperature of 850° C. The granules were a terracotta colour and were extremely hard. They were found to absorb 34 wt % of water (wt of water/wet wt of granules). The pore size was found to be:

| | |
|---|---|
| 90% | 30 to 300 microns |
| 5% | 300 to 500 microns |
| 5% | Less than 30 microns |

This proved to be an excellent potting mix when granulated to give a particle size range of 33% 0.1 to 0.5 mm, 33% 0.5 to 2 mm and 33% 2 to 5 mm, giving a uniform water release over suctions from 1 Kpa to 10 Kpa the level defined as readily available water to plants.

### EXAMPLE 2

Example 1 was repeated but with an air flow increased to 10 m³/min. The combustion temperature rose to 950° C. and some of the granules were observed to stick together. When cold they were white in colour and were found to have a water absorption of only 24 wt % due to excess shrinkage during the calcining.

It will be appreciated that the present invention recognises that the energy released by the combustion of the sawdust is not only sufficient to fuel the calcining and drying process, but also produces surplus energy which can be utilised for other purposes. The energy produced may be up to four times that required for calcining.

Effective harnessing and utilisation of this combustion energy can open the possibility of producing calcined porous clay granules at relatively low cost. This is achieved with the present invention, which consists of a continuous and integrated process for the production of porous calcined clay. Use of waste clay and waste sawdust or other organic wastes would enable this process to be low cost.

This enhances its ability to be extruded or otherwise handled. However, other clay materials may be used such as heat powder dried clay or solar dried clay. In this way a dry material may be useful in transporting to the manufacturing site. However, water will need to be added in order to provide the necessary malleable smooth material.

The term “cellulosic material” is used herein in its broadest sense and refers to any material containing cellulose or cellulose compounds. Examples include sawdust, wood flour, paper pulp or sludge, sewage or vegetable matter. The cellulosic material is preferably a cellulosic waste such as waste paper sludge from waste paper recycling plants or wood waste for example from a timber mill or furniture factory. Preferably, the cellulosic waste is added to produce densities in the range of about 0.3 to about 1.5 g/cc.

The term “carbonaceous material” is used herein in its broadest sense and refers to any material containing carbon or carbon compounds. Examples include coal such as brown or black coal, peat, lignite and charcoal.

b) General Process

The siliceous material is mixed with the cellulosic and/or carbonaceous material using any suitable known apparatus, such as, for example, a planetary, pug, ribbon or paddle mixer.

The mixture generally has the consistency of a dough, which is advantageously pelletised, by extruding through a die and chopping or by going through a pellet mill before being subjected to calcination. An extruder performs the extrusion. The pellets or extrusion are dried before calcination. This assists in reducing the amount of time required for calcination, which results in a more economical process.

The shaping of pellets may be achieved using any suitable known technique such as, for example, rotation in a large drum. It will be appreciated that the size of the pellets can be controlled by the size of the die orifices. The pellets may be about 40 mm or less in diameter and generally range in size from about 0.5 to about 30 mm in diameter.

Referring to FIG. 1, combustible material is provided in the form of wood waste or similar material at 10. Before mixing with non-combustible material 12, the wood waste 10 is preferably dried and comminuted. Where the combustible material is not wood waste, for example waste paper pulp, this initial drying step may be excluded. The mixture is then mixed in mixer 14 before being formed into agglomerates in extruder and chopped 16. After chopping the pellets are then shaped and dried in drier 18 and passed to the furnace 20. Calcination of the non-combustible material occurs in the furnace 20 and porous, calcined granules exit from the furnace 20.

The term “calcination” is used herein to refer to heating the clay for a time up to its softening temperature, causing partial fusion during which and pores or voids are formed when the cellulosic and/or carbonaceous material is burnt away. It is preferable that the reduction of the cationic exchange properties of the mixture are minimised by minimising calcination temperature and calcination time. Calcination is preferably carried out at a temperature of greater than about 400° C., more preferably from about 400 to about 1100° C., most preferably about 600 to about 900° C. The duration of calcination will depend on the amount and type of material present in the mixture, but is generally complete after about 1 minute to about 5 minutes at about 800 degrees C. This step usually results in the removal of most of the salts including sodium chloride. The calcination may be carried out in any suitable known apparatus such as a fluidised bed apparatus, rotary calciner or furnace but must be carried out in a furnace as shown in FIG. 2 to produce low cost porous granules.

c) Drying and Comminuting

Referring to the drying and comminution processes, which occur before pelletising, combustible material in the form of wood waste is dried at 260C or less to achieve a water content of less than 30% and ideally less than 13% in an over. Residence time in the oven may be up to 10 minutes when wood waste is of a particle size range 5 mm to 10 mm and is dried at a temperature of 260C.

Comminution of the dried wood waste may be performed using existing milling methods and equipment. Comminution of the dried wood waste serves to reduce the wood waste to smaller fragments the size of the fragments of sawdust determining the size of the pores in the porous, calcined granules finally produced. Prior to comminution, the size of the wood waste particles may be in the range up to 10 mm. After comminution, the particle size distribution is typically 5%: 300 microns to 1 mm, 90%: 30 microns to 300 microns, and 5%: less than 30 microns.

The invention preferably makes use of a novel shear action comminution of the coarse dry sawdust to be used in the production of porous clay granules. Hammermills are used to pulverise material into small particle sizes (dependent upon sieve size used). In doing this hammermills work concentrically and need a comparatively large energy requirement to perform the job at hand.

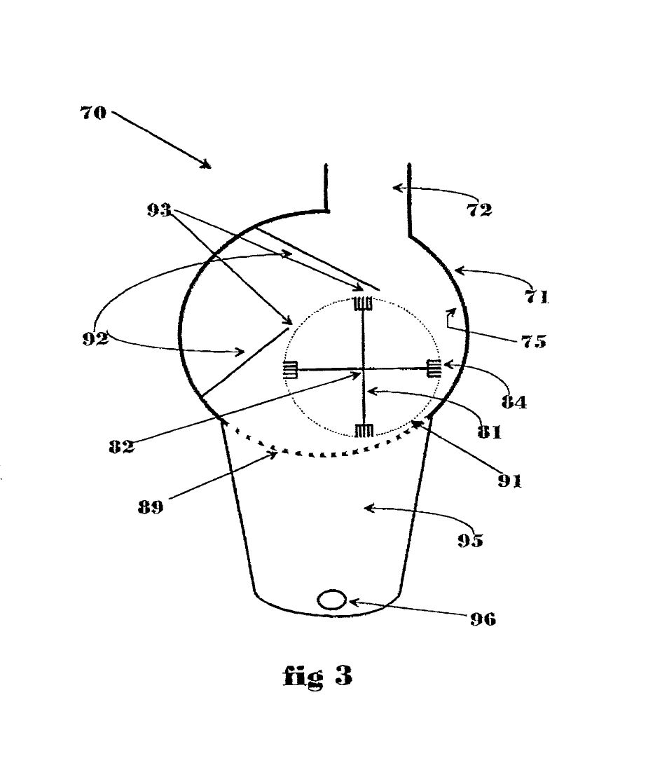

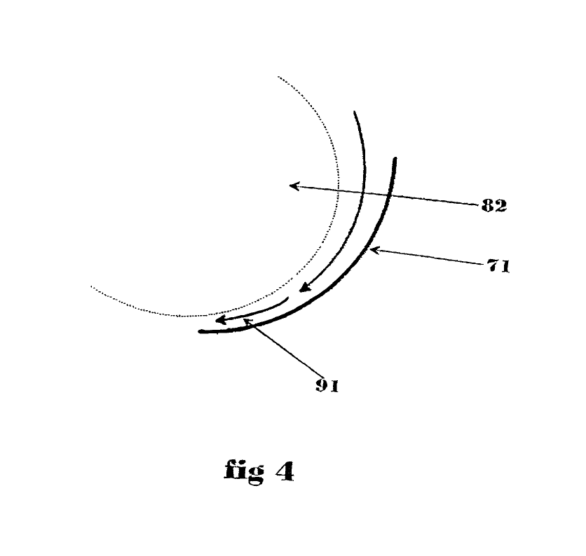

Referring to FIGS. 3 and 4 there is shown a comminutor 70 comprising a substantially circular working chamber 71 fed material through a top input chute 72 and having an output chute 95 extending from a lower portion of working chamber 71. The working chamber 71 includes a curved internal working surface 75 which has an arc of curvature defined by the diameter of the circular working chamber 71. Generally this may have a diameter of about 0.5 meters.

Mounted within the working chamber 71 is a plurality of four rotating arms 81 mounted at a rotating arm mount 82 which is offset to the center of the working chamber 71 so as to be eccentrically mounted, the rotating arms 81 within a circular cross sectional working chamber 71. Clearly the rotating arms 81 have a diameter less than the diameter of the working chamber 71 so as to fit therein and a length less than the distance between the rotating arm mount 82 and the curved internal working surface 75. In this way the end of the rotating arms 81 come close to but do not touch the curved internal working surface 75 and define a primary nip area 91 being a position at which the minimum distance between the end of the rotating arms 81 and the curved internal working surface 75 occurs. The rotating arm mount 82 is generally set to the right of the center of the working chamber 71 and below the center of the working chamber 71 so as to define the primary nip area 91 at a lower right position. The rotating arms 81 are mounted for rotation in a clockwise direction.

The working chamber 71 further includes baffle plates 92 extending from the inside surface 75 of the working chamber 71 towards the rotating arms 81 and forming secondary nip points 93 with a 3 mm gap left between the baffle plate 92 and the rotating arms 81. The secondary nip points primary nip area 91 has a 2 mm gap. The baffle plates 92 prevent fine material forming clouds within the working chamber 71 and entices them back towards the rotating arms 81 and the primary nip area 91.

The end of the rotating arms 81 include fingers 84 in order to encourage movement of the material against each other particularly at the nip areas 91, 93 so as to provide shear forces and thereby comminution of the material. At a bottom portion of the working chamber 71 is a mesh 89 of a size suitable to allow a path for the required sized comminuted material. The outward chute 95 comprises a suction chamber leading to an exit pipe 96, which leads to a storage hopper.

It can thereby be seen that the invention provides an eccentric configuratively designed comminutor that simultaneously increases performance (achieves substantially higher output rates) while lowering energy requirements (decreases operating costs). In other words the eccentric configuratively designed comminutor comminutes more material at a lower operating cost. This is possible because the weight of the rotor generates dynamic horsepower and effectively utilises that stored energy to comminute the material at the ‘nips’ (see nip point on drawing.

It is essential to find a cost-effective method of comminuting coarse dry wood waste (obtained from sawmills and other sources) in the particle size range of 30 microns to 300 microns. This size range would provide a similar size range of voids in the granules, and enable plants to extract water at suctions of between 1 kPa and 10 kPa. (which would normally be considered necessary to provide a maximum of ‘readily available water’).

Initial trials on a hammer mill which relied on the action of impacting the sawdust on flailing plates rotating at high speed to break the sawdust down, were not very successful. Several low feed rate passes of the sawdust by recycling were necessary to obtain the desired degree of comminution and to avoid undue slowing down and overheating of the motor.

It is conjectured that amore efficient action may result using ‘shear’ action rather than impact, bearing in mind the general toughness of wood fibres in resisting impact). This principle is well known for example in emulsification and homogenising processes where water/oil or fat coarse mixtures are passed between a narrow gap between contra rotating plates. A not too dissimilar process is used for grinding brittle materials such as peppercorns or wheat (an ‘energy mill’) but the rough surfaced plates, which are set very close together, rely more on a direct grinding action. Several passes would again be required using a gradually reducing gap.

In this invention a much wider gap between a moving and static surface is used relying on the shear generated within the medium itself. Although some impact action occurs due to the placement of baffle plates in the apparatus it s relatively to a much lesser extent. Instead of using rough rotating surfaces, which are provided for example by a stone, or a textured steel surface, we use very stiff wire bristles in a modified brush arrangement. This ensures a tight ‘grasp’, or hold, of one side of an individual particle to take place as another sawdust particle scrap passed. Another rough surface is provided by a coarse wire screen, which also allows the comminuted material to pass through.

Further details of this arrangement will be described in the examples below illustrating the various creative steps as they arise.

Advantages of the system over other methods of comminution are first summarised as follows:

1. Only one pass of even very coarse sawdust or wood waste of 2 to 10 mm particle size through the comminutor is necessary. Several passes, using either a gradually diminishing gap or in the case of hammer mills gradually reducing screen sizes, are not required.

2. Much higher throughput rates at much lower energy input rates are achieved with the comminution system.

3. The capital cost of the apparatus is much lower than a hammer mill that could produce equivalent outputs.

4. The system is safer as over heating of the product giving rise to ignition and internal fire as is fairly common with hammer mills does not occur.

### EXAMPLE 1

A preliminary trial was first carried out using the very simple arrangement in diagram 1. It comprised a steel tube with a 1 mm mesh fixed and stretched over the base. Pre-dried coarse sawdust obtained from a log sawmill was introduced into the vertical tube at various depths up to about 50 mm. A tight fitting solid wire brush driven by an electric drill is introduced into the tube and is forced down onto the sawdust. Much of the sawdust escaped to the space above the brush even though it is very tight fitting. However some comminution did occur. The process is most effective when the gap between brush and screen is quite narrow and a pumping action of the brush is used. Very fine material is collected and found mainly to pass through a 60 mesh, 250 micron sieve. The rate however was very low.

The log mill wood waste is dried at about 265 degrees Celsius until it goes a slightly darker shade in colour and the experiment is repeated. A low but increased output rate is obtained.

The experiment is also repeated using a lightly fitting hollow wire brush or ‘cup brush’. There is little difference in output rate.

### EXAMPLE 2

A different arrangement using a rotating wire brush 25 mm in thickness in the form of a wheel commonly used on a grinding wheel for removing rust from metal and the like is constructed according to diagram 2. The wire brush rotated inside a closed circular chamber comprising two steel plates bolted to a peripheral spaced 26 mm in thickness. A 1 mm wire screen is incorporated at the bottom of the circular enclosure and a funnel for introducing the sawdust is incorporated in the top. The brush did not rotate concentrically within the circular enclosing box but is offset leaving a gap of about 2 mm between bristle surface and screen. This generated a nip, which trapped the sawdust in a tapering space in which increasing pressure could be generated creating a high shear force. Consequently a system providing a mechanism to shear the sawdust is invented.

However during the first trial of this system it is found that the shearing of the sawdust is at a lower rate than expected. Much of the sawdust is being flung centrifugally around the periphery of the chamber. Accordingly two baffle plates were incorporated to prevent this. Advantageously two further nips about 3 mm wide, at which further shearing could occur, were also created. A significant increase in output was obtained but not to a satisfactory level. In order to improve on this system it is thought that introducing gaps (spaces) along the brush may solve the problem. So gaps were machined out of the wire brush to give six equally sized and spaced segments of bristles separated by six air spaces. The size of the spaces and segments were the same. It is reasoned that this would prevent sawdust from being forced through the nip causing bristle distortion and reducing shearing action. Instead the voids would serve as a buffer reservoir reducing compaction pressure and exert pressure by centrifugal force. This would also cause high speed impact of sawdust against the peripheral plate as well as the baffle plates creating further comminution. This modification produced a considerable increase in comminuted wood waste output. It is further found there is little difference in throughput using sawdust dried to a 13 wt % moisture content to material that had been completely dried to a level of slight material degradation (browning).

### EXAMPLE 3

A scaled up apparatus shown in FIG. 3 is built. This time the comminution chamber is 500 mm in internal diameter and 1 meter in length. The bristles were replaced by four peripheral zones of stainless steel nails extending the full length of the rotor and about 25 mm in width. The nails were 2.8 mm in diameter and spaced about 5 mm apart. The rotor 450 mm in diameter is offset as in example 2 to give a gap of 2 mm just at the beginning of the screen. A similar arrangement of baffle plates is also used. Air is drawn through the screen to prevent blinding of comminuted sawdust within the rotor chamber and to convey the material to a cyclone separator. To prevent build up directly below the screen an orifice of 15 mm diameter is drilled at the suction end of the casing below the screen level. This configuration creates a venturi and prevents build up of sawdust under the screen.

Ultra fine dust (approx. Below 30 microns) produced is directed to the clay/sawdust mixture extrusion head to prevent pellets from sticking together. It is found that when rotating at 1000 rpm and using sawdust of 13% moisture content that a throughput of 3 cubic meters per hour is obtained. At 1950 rpm a throughput of 4 cubic meters is obtained. About 60\% of the comminuted material passed through a 30 mesh sieve and 40% through a 60 mesh sieve. Very little of the material is large than 30 mesh.

The invention comminutes all material in 3 nip zones. Very low power consumption is required for this to occur. Configuration of the bristle also contributes to the energy efficiency by dispersing the material in a negative form. This means the material being comminuted performs the task by acting against like material, due to the configuration of the bristles.

The design of the eccentric comminutor also allows for the re-agitation of residual material to continually pass through the nip until the desired particle size is achieved (which is dependant upon the screen size fitted).

The eccentric comminutor will produce a cubic meter of comminuted sawdust (comminuted to less than 500 microns) in 20 minutes using a 3 HP motor (the motor only uses 2 amps per phase under load).

It is important to appreciate that shear action comminution apparatus plays two further critically important roles in production process in addition to the comminution of coarse dry sawdust. Those roles are: 1. To direct ultra fine sawdust particles (less than 30 microns) onto the production processes extruder head to prevent the extruder pellets from sticking together during the shaping of the pellets into spheres stage, which occurs n the rotating drier and 2. The directing of air into the dryer to play a critically important role in the drying of pellets and regulation of temperature in the rotating pelletising cylinder.

d) Mixing of Comminuted Material

The clay and comminuted combustible material are then mixed into a dough and extruded to form pellets. The mixing can be done using any suitable known apparatus, such as, for example, a planetary, pug, ribbon or paddle mixer. Once the material is mixed it is transferred to the extruder to enable it to be pelletised.

e) Pelletising

After the clay and sawdust has been mixed in the mixer the combined material is extruded through a die. While being extruded a cutter cuts the material into pellets. Due to the extrusion and cutting the resultant pellets are squat cylindrical shapes. In order to improve the product for the next step of calcination and to arrive at a pleasing final product two further process steps are required. Firstly the pellets need to be shaped into balls and secondly the pellets must be dried.

Both of these steps are achieved by delivering the pellets into a rotary drum. The action of the pellets on each other and the drum by the rotary action results in rounded balls. At the same time a stream of hot air is pumped into the drum to dry out the pellets and provide dry input material for calcination.

f) Calcination

The pellets are dried and calcined. In this invention these two stages are preferably integrally linked and make use of the heat generated by combustion of the sawdust during calcining.

In general, the pellets can be dried in any conventional manner, for example in a horizontal rotating cylinder through which hot air is blown. Alternatively, the wet granules are allowed to continuously pass under gravity through a vertical tank or drum through which hot air from the calcining furnace is blown, falling out through an exit hole in the bottom directly into the calcining furnace. They are dried by rapid flow of hot air which is achieved through combination of exhaust heat from the furnace and input of cold air) the temperature being sufficient to rapidly dry the spheres but not to cause ignition of the comminuted sawdust). The drying process is very rapid and takes approximately 2 to 3 minutes depending on granule size, using a temperature of about 300C.

A novel furnace may also be constructed substantially avoiding the high cost and energy consumption of other apparatus.

Referring to FIG. 2 furnace 20 consists of a static, vertical, stainless steel cylinder 21, which is a closed system. The axis of the cylinder is aligned vertically. A rotary valve 22 is located at the top end of the cylinder 21, offset from the axis of the cylinder, through which the pre-dried granules are fed directly from the dryer 18. Exhaust gases from the furnace are fed upwardly into the dryer 18 by ducts 28, 30 at the top of the furnace. A heating element (not shown) is located on the air inlet to the furnace 20 so that heated air is introduced into the furnace 20 to initially ignite the material. The method of heating the air can either be electrical, gas or solid fuel.

Uncalcined material is introduced into the furnace preferably at a rate of at least 1 cm (depth) per minute. The flow rates of uncalcined granules into the furnace 20 and calcined granules out of the furnace are controlled in order to maintain a predetermined level of the granules in the furnace. This level is maintained at the radially extending paddles 32. A space of at least 300 mm is left free above the burning granules as the combustion zone of the gases. This is essential to prevent smoke from being generated.

As the granules enter the furnace 20, they are spread by a series of paddles 32 at the top of the cylinder 21, which are attached to a central rotating pipe 26. The central pipe 26 is attached to a variable speed drive (not shown). There are preferably four evenly spaced, radially extending paddles 32, which rotate with the central pipe 26. The paddles 32 ensure that the material is spread evenly across the cylinder 21 as it begins to moves downwardly through the furnace 20. As the material diffuses downwardly it passes successively through pre-heating 35, hot 36, and cooing 38 zones before exiting the furnace 20 at the lower end thereof.

In the pre-heating zone 35, hot gases from the hot zone 36 of the furnace flow upwardly through the material enabling the incoming material to be fully snap dried and partially combusted as it is being evenly spread by the paddles 32.

The granules continue to move downwards and calcining of the granules takes place spontaneously in the hot zone 36, which is formed at a controlled optimum height within the cylinder 21. As the granules fall on the hot material they quickly turn black due to carbonisation of the fuel and burn with a flame. As they pass down through the furnace 20 they start to glow red hot about 1 to 2 cm beneath the surface and continue to glow for a further 2 or 3 cm as the carbon near the surface of the granules is burnt. The temperature of this red hot zone is preferably maintained at 700° C. to 900° C. by controlling air flow. At temperatures below 700° C. not all the carbon residues will have burnt away and the granules will be weaker in strength due to inadequate fusing of the clay colloidal particles.

As the red hot granules pass further down the furnace 20 they turn black as they slowly run out of fuel. This black zone will extend for about a further 10 cm when most of the fuel has burned away. At this stage they will slowly cool although low levels of carbon residues will be slowly oxidised at the center of the granules. This cooling zone 38 is about a further 300 mm in depth. Cooling is achieved by air flow into the furnace 20 through air inlet 24, which is blown downwards into the cooling zone 38 by rotational air sparge 34. The rotating air sparge 34 is connected to the central rotating pipe 26 at the lower end thereof. The sparge consists of six radially extending pipes 34 which are preferably welded to and rotate with the central pipe 26 at the same speed as the paddles 32.

The granules move downwards through the cooling zone 38 and when cooled exit through a rotational valve 40. The granules can then be bulk stored or loaded or can be bagged.

The speed of combustion will depend on granule size and smaller granules will burn out faster than larger ones since the fuel is more available. The combustion depth described is for granules of about 10 mm in diameter. Granules of 1 mm or less will burn much faster and the depth of the combustion zone is adjusted accordingly.

Cycle time may be regulated by the air flow and feed rates. A short residence time can help ensure that the calcining process does not diminish nutrients and/or cation exchange capacity of the clay significantly. This would be important for horticultural applications of the product.

Varying one or more of the following can control the interior temperature of the furnace:

a) Air regulation and distribution, which is achieved by varying the rotational speed of the sparge and the pressure of the air flowing through the sparge.

b) Regulation of the speed of input of material through the rotary valve at the top of the unit.

c) Regulation of the speed of output of material through the rotary valve at the bottom of the unit.

Exhaust gases from the unit are further diluted by cold air and are then used for the pre-drying of the granules.

It will be appreciated that the furnace is a significant energy source. Surplus energy contained within the exhaust gases can be used for roasting of the sawdust, generation of electricity, or distillation of water from clay slurry.

It will also be appreciated that some waste clay slurries have a high salt content, as high as 6000 ppm, which has been reduced to about 100 ppm using the process of the invention. Allowing a longer residence time in the furnace assists in reducing the salt content in the calcined product, which is desirable for horticultural applications of the product. The cation exchange capacity and/or nutrient content of the calcined clay can be enhanced by adding particular clays such as montmorillinite and illite during the mixing process.

The low cost, porous calcined clay pellets, spheres or granules produced with this invention will have several applications. Within horticulture the water absorption and water availability, air porosity, nutrient availability, and cation exchange capacity enable them to be used as:

1. Hydroponic growing medium

2. A propagation media, used in the nursery industry to propagate plant cuttings

3. A wetting agent carrier, added to composted pine bark and other potting mixes to give the potting mix improved wettability

4. A potting mix additive, added to composted pine bark to give the potting mix improved buffering and cation exchange capacity as well as improved water holding capacity. The porous clay granules can be a substitute for perlite, vermiculite, peat, coir fibre etc. presently used. In addition the replacement of larger pine bark particles (more than 5 mm) with porous clay granules would improved water absorption and water availability of the mix.

5. Potting mix growing media in their own right, with differing optimum levels of air porosity and water availability being achieved for different plants by varying the particle size distribution of the sawdust and of the particles.

A growing medium with particle size range from 0.5 mm to 3 mm is manufactured using the process and is found to have a porosity of 22 volume percent and water absorption of 45 volume percent (most of which would have been readily available water). Very low cost production of the porous calcined clay granules can open the possibility of using them as an engineered soil to replace deteriorated and/or eroded agricultural soils.

Other possible applications for the low cost porous calcined clay granules, pellets or spheres include industrial oil absorbent, pet litter, or filtering material.

1. A method of producing porous calcined granules of a non-combustible material, the method including:
preparing agglomerates of said non-combustible material and a combustible material;
calcining said agglomerates in a calcining furnace comprising a substantially enclosed chamber with an inlet at the top and outlet at the bottom and divided into a top section and a bottom section by a frame means, and the furnace further including a heating means for heating the agglomerates in the top section, a movement means for moving the agglomerates, and a cooling means for cooling the calcine product in the lower part of the furnace;
the heating means able to ignite an initial batch of agglomerates in the top section and by control of the inflow of agglomerates and movement of agglomerates and the air flow, the calcining process is essentially self-sustaining without further use of the heating means.

2. A method of producing porous calcined granules according to claim 1 such that the step of preparing agglomerates includes at least partially drying the agglomerates in a rapid flow of hot air obtained as exhaust from the calcining furnace.

3. Porous calcine granules of a non-combustible material produced by the method of claim 1.

4. A method of producing porous calcined granules of a non-combustible material, the method including forming agglomerates of said mixture, at least partially drying said agglomerates, and calcining the agglomerates in a furnace such that energy generated by combustion of the combustible material is at least partially utilised for said calcining.

5. A method according to claim 4 with said calcining being initiated by igniting the at least partially dried agglomerates.

6. A method according to claim 5 such that the calcining is sustained by the energy released by combustion of the combustible material.

7. A method according to claim 6 such that the combustible material is dried to a water content of less than 30 wt %.

8. A method according to claim 5 such that the combustible material or the incombustible material is comminuted prior to formation of the agglomerates.

9. A method according to claim 8 such that the agglomerates of combustible material and non-combustible material are formed as pellets or spheres.

10. A method according to claim 8 such that the combusted material is incorporated interstitially in the non-combustible material.

11. A method according to claim 7 such that the agglomerates are at least partially dried by subjecting the agglomerates to a rapid flow of hot air which at least partially includes exhaust heat from the calcining process.

12. A method according to claim 8 such that the combustible material or the incombustible material is comminuted in a working chamber with curved internal working surface and an input leading into the working chamber and an output leading out of the working chamber; a rotating arm mounted eccentrically within the working chamber forms a primary nip position at the closest point between the end of the rotating arm and the curved internal working surface such that the material to be comminuted is fed into the input and is comminuted at the nip position by shear forces caused by the comminuted material being forced to move by the rotating arm relative to material on the curved internal working surface.

13. A comminutor for comminuting material to a required size comprising: a working chamber with curved internal working surface and an input leading into the working chamber and an output leading out of the working chamber; a rotating arm mounted eccentrically within the working chamber so as to form a primary nip position at the closest point between the end of the rotating arm and the curved internal working surface; wherein the material to be comminuted is fed into the input and is comminuted at the nip position by shear forces caused by the comminuted material being forced to move by the rotating arm relative to material on the curved internal working surface.

14. A process for the production of porous granules, which includes the steps of:
(a) mixing at least one siliceous materials with another or with at least one cellulosic and/or carbonaceous material; and
(b) subjecting the mixture to calcination.

15. A process for the production of porous granules which includes the steps of:
(a) mixing at least one siliceous materials with another or with at least one cellulosic and/or carbonaceous material, comminuting at least one of said material in a comminutor according to claim 13; and
(b) subjecting the mixture to calcination.

16. A calcining furnace comprising a substantially enclosed chamber with an inlet at the top and outlet at the bottom and divided into a top section and a bottom section by a frame means, and the furnace further including a heating means for heating the agglomerates in the top section, a movement means for moving the agglomerates, and a cooling means for cooling the calcine product in the lower part of the furnace; the heating means able to ignite an initial batch of agglomerates in the top section and by control of the inflow of agglomerates and movement of agglomerates and the air flow, the calcining process is essentially self-sustaining without further use of the heating means.

17. A process for the production of porous granules which includes the steps of:
(a) mixing at least one siliceous materials with another or with at least one cellulosic and/or carbonaceous material; and
(b) subjecting the mixture to calcination in a calcining furnace according to claim 16.
